(19) United States
(12) Patent Application Publication
(10) Pub. No.: US 2010/0092048 A1
(43) Pub. Date: Apr. 15, 2010

(54) FINGERPRINT INFORMATION STORAGE APPARATUS USING SECRET DISTRIBUTION TECHNIQUE, FINGERPRINT AUTHENTICATION SYSTEM USING THE SAME, AND FINGERPRINT AUTHENTICATION METHOD USING THE SAME

(75) Inventors: Sung Bum Pan, Gwangju (KR); Sung Jin Lim, Gwangju (KR); Yong Wha Chung, Daejeon (KR); Han Na Choi, Seoul (KR)

Correspondence Address: BARDMESSER LAW GROUP, P.C., 1025 CONNECTICUT AVENUE, N.W., SUITE 1000, WASHINGTON, DC, 20006, US

(73) Assignee: Industry-Academic Cooperation Foundation, Chosun University, Gwangju (KR)

(21) Appl. No.: 12/409,589

(22) Filed: Mar. 24, 2009

(30) Foreign Application Priority Data
Oct. 9, 2008 (KR) 10-2008-0098915

(51) Int. Cl. G06K 9/00

(52) U.S. Cl. 382/125

(57) ABSTRACT

A fingerprint information storage apparatus includes a fingerprint information generating unit that extracts minutiae information from an authenticated user's fingerprint image and generates fingerprint information by inserting chaff minutiae information into the extracted minutiae information, a fingerprint information distributing unit that classifies the fingerprint information according to the extent that minutiae are distributed relative to the center of the fingerprint and distributively outputs the fingerprint information classified according to the distribution, and a first fingerprint information storage unit and a second fingerprint information storage unit that store the fingerprint information and distributively output according to the distribution, wherein the authenticated user's fingerprint information registered in the first fingerprint information storage unit is partially aligned and input fingerprint information is converted based on the information so that the converted input fingerprint information and the fingerprint information registered in the second fingerprint information storage unit are aligned.

### CROSS REFERENCE TO RELATED APPLICATIONS

This application claims priority to Korean Patent Application No. 10-2008-0098915, filed on Oct. 9, 2008 in the entire contents of which are hereby incorporated by reference.

### BACKGROUND OF THE INVENTION

1. Field of the Invention

The present invention relates to a fingerprint information storage apparatus, a fingerprint authentication method, and a fingerprint authentication system, and more particularly, to a fingerprint information storage apparatus using an authenticated user's security token-based secret distribution technique, a fingerprint authentication method using the same, and a fingerprint authentication system using the same.

In particular, the present invention relates to biometric information security, and more particularly, to a security token-based fingerprint authentication method that can keep personal fingerprint information more securely using a fuzzy vault, by keeping a portion of a user's fingerprint information using a security token, and can perform a fingerprint authentication more securely and efficiently by efficiently aligning the concealed fingerprint information and matching it with input fingerprint information and to a system thereof.

2. Description of the Related Art

Recently, a method of using a user's fingerprint information has been introduced in a user authentication system. However, if a fingerprint is stolen by others, the change of the fingerprint is impossible, unlike from a password, and the change thereof is limited, such that the user's fingerprint information must be kept more secure.

Therefore, there is a need for a method to more securely keep fingerprint information so as to protect fingerprint information using cryptography, such as a fuzzy vault using fuzzy logic. This is a method for generating chaff minutiae using a random function and constituting a fingerprint template together with a user's real minutiae.

However, in such a fingerprint fuzzy vault system, there is a difficulty in distinguishing the real minutiae and the chaff minutiae from the fingerprint template, such that security in fingerprint information may be a problem.

Numerous study results that apply such fuzzy vault theory to fingerprint have been recently published. However, since the size of a fingerprint image received from a fingerprint sensor is limited, a problem arises in that the maximum number thereof into which the chaff minutiae can be inserted is limited. In other words, if a relatively large number of chaff minutiae compared to the number of minutiae in the limited range that can be extracted from the user's fingerprint are inserted to the fingerprint template, a problem arises in that fingerprint recognition rate is abruptly deteriorated.

### SUMMARY OF THE INVENTION

Accordingly, it is an object of the present invention to provide a method to improve security of a security token-based fingerprint fuzzy vault system using a secret distribution technique without deterioration in performance of fingerprint recognition rate, and a method to perform a fingerprint authentication using a method to apply a geometric hashing technique distributively in order to solve the problem of auto-alignment generated when the fuzzy vault theory is applied to the fingerprint and a system thereof.

Another object of the present invention is to provide a fingerprint authentication system that can more safely protect the fingerprint information by distributively storing a fingerprint template generated by applying the fuzzy vault theory in the security token and a server in a secret distribution technique; and by allowing the entirety of the fingerprint information to not be known even if either the security token or the server is attacked, and a fingerprint storage apparatus for the same.

To achieve the above objects, according to one aspect of the present invention, there is provided a fingerprint information storage apparatus using a secret distribution technique, including a fingerprint information distributing unit that classifies an authenticated user's fingerprint information according to the extent that minutiae are distributed relative to the center of the fingerprint and distributively outputs the fingerprint information classified according to the distribution; and a first fingerprint information storage unit and a second fingerprint information storage unit that store the fingerprint information distributively output according to the distribution.

In the present invention, two storage units, where the generated fingerprint information is distributively stored are shown, but the present invention is not particularly limited thereto. In some cases, three or more storage units may be formed, for example.

In particular, the first fingerprint information storage unit may correspond to a server and the second fingerprint information storage unit may correspond to a security token. For example, the first fingerprint information storage unit may be constituted to have a storage capacity larger than the storage capacity of the second fingerprint information storage unit, the present invention is not particularly limited thereto.

The security token may be a security token owned by an authenticated user.

The storage unit where the authenticated user's fingerprint information is stored and registered is constituted doubly or multiply to allow the whole fingerprint information not to be known although any one storage unit is attacked, thereby securely protecting the fingerprint information and improving the security thereof.

In the present invention, the number of minutiae stored in the security token may be less than the number of minutiae of the authenticated user.

In the present invention, the fingerprint information generating unit may include a real fingerprint information generating unit that extracts minutiae from the authenticated user's fingerprint image input by a sensor and registers fingerprint information including a position, an angle, a shape, and a distribution relative to the center of the fingerprint, of the minutiae, and a negative real fingerprint information generating unit that generates chaff fingerprint information including a position, an angle, a shape, and a distribution relative to the center of the fingerprint, of the minutiae, and inserts the generated chaff fingerprint information into the registered real fingerprint information.

To achieve the above objects, according to another aspect of the present invention, there is provided a fingerprint authentication system using a secret distribution technique, comprising: an input fingerprint information generating unit that extracts minutiae from an authenticated user's input fingerprint image and generates fingerprint information including a position, an angle, a shape, and a distribution relative to the center of the fingerprint, of the minutiae; an input hash table generating unit that generates an input hash table with the input fingerprint information using a geometric hashing technique; a primary registration hash table generating unit that extracts pre-registered fingerprint information from a first fingerprint information storage unit that extracts minutiae information from an authenticated user's fingerprint image, generates fingerprint information by inserting chaff minutiae information into the extracted minutiae information and is stored with fingerprint information of the fingerprint information, having low distribution relative to the center of the fingerprint, and generates a primary registration hash table using a geometric hashing technique; a primary fingerprint information aligning and matching unit that matches fingerprint information by aligning the input hash table and the primary registration hash table and then deletes chaff fingerprint information; a partial alignment fingerprint information generating and transmitting unit that generates partial alignment information using the aligned and matched fingerprint information and the input fingerprint information and transmits it to a second fingerprint information storage unit; a secondary registration hash table generating unit that extracts pre-registered fingerprint information from the second fingerprint information storage unit stored with fingerprint information of the authenticated user's fingerprint information, having a high distribution relative to the center of the fingerprint, and generates a secondary registration hash table using a geometric hashing technique; a partial input hash table generating unit that generates a partial input hash table of the input fingerprint information using the geometric hashing technique and the transmitted partial alignment fingerprint information; a secondary fingerprint information aligning and matching unit that matches fingerprint information by aligning the partial input hash table and the secondary registration hash table and then deletes chaff fingerprint information; and a user authenticating unit that detects authentication results of the input fingerprint information from the primary fingerprint information aligning and matching unit and the secondary fingerprint information aligning and matching unit.

In the present invention, the primary registration hash table generating unit, the primary fingerprint information aligning and matching unit, and the partial alignment fingerprint information generating and transmitting unit may be a server, and the secondary registration hash table generating unit, the partial input hash table generating unit, and the secondary fingerprint information aligning and matching unit may be a security token, but the present invention is not particularly limited thereto.

The security token is merely one example of a security storage apparatus owned by an authenticated user, and, thus, it may be replaced by any storage apparatus, as is known in the art.

To achieve the above objects, according to yet another aspect of the present invention, there is provided a fingerprint authentication method using a secret distribution technique, including the steps of: distributively registering fingerprint information that extracts minutiae information from an authenticated user's fingerprint image, generating fingerprint information by inserting chaff minutiae information into the extracted minutiae information, registering a portion of the generated fingerprint information in a first fingerprint information storage unit, and registering other fingerprint information, which is not registered in the first fingerprint information storage unit, in a second fingerprint information storage unit; aligning primary fingerprint information that aligns the fingerprint information registered in the first fingerprint information storage unit and input fingerprint information; generating partial alignment fingerprint information of the fingerprint information registered in the first fingerprint information storage unit and the input fingerprint information and transmitting it to a second fingerprint information storage unit; aligning secondary fingerprint information that aligns the input fingerprint information using the transmitted partial alignment fingerprint information and the fingerprint information registered in the second fingerprint information storage unit; and detecting authentication results that determines whether the input fingerprint information is matched with the authenticated user's fingerprint information using the results from the aligning the primary fingerprint information and the aligning the secondary fingerprint information.

In the fingerprint authentication method according to one embodiment of the present invention, the first fingerprint information storage unit, for example, has a larger storage capacity and reinforced security compared to the second fingerprint information storage unit. Therefore, a portion of the authenticated user's fingerprint information distributed and stored in the first fingerprint information storage unit may be information on fingerprint minutiae having higher reliability compared to the fingerprint information distributed and stored in the second fingerprint information storage unit. The judgment reference of the fingerprint minutiae having high reliability is not specifically limited, but it may be selected based on a judgment index that can be derived from contents publicly known to those skilled in the art.

Preferably, fingerprint minutiae positioned near the center of the fingerprint may have higher reliability compared to minutiae positioned in other positions. Therefore, the distance indicating how far the minutiae are from a central point of the fingerprint or the extent showing how the minutiae are distributed relative to the central point of the fingerprint, etc. (distribution) may be considered as the judgment reference of the reliability for the fingerprint minutiae.

In the fingerprint authentication method according to one embodiment of the present invention, the fingerprint information stored in the first fingerprint storage unit may be fingerprint information that extracts minutiae information from the authenticated user's fingerprint image and has a low distribution of the minutiae when the minutiae are classified according to the extent that the minutiae are distributed relative to the center of the fingerprint.

At this time, the fingerprint information in which the minutiae have a low distribution means fingerprint information of the minutiae having distribution ranked lower than 50%, when the distribution of the whole fingerprint minutiae of the authenticated user is arranged sequentially from a low ranking to a high ranking. Since the distribution is determined relative to the center of the fingerprint, the minutiae positioned far from the center of the fingerprint have a high distribution and the minutiae positioned closer to the center of the fingerprint have a low distribution and are thus considered as being concentrated.

In the fingerprint authentication method according to the present invention, the first fingerprint information storage unit may be a server and the second fingerprint information storage unit may be a security token. Preferably, the number of minutiae stored in the security token is less than the number of minutiae of the authenticated user.

In the fingerprint authentication method according to the present invention, the minutiae information may be at least one selected from a position, an angle, a shape, and a distribution relative to the center of the fingerprint, of the minutiae.

Preferably, the step of aligning the primary fingerprint information and the step of aligning the secondary fingerprint information includes generating and aligning respective hash tables with the fingerprint information registered in the first fingerprint information storage unit, the input fingerprint information, the input fingerprint information using the transmitted partial alignment fingerprint information and the fingerprint information registered in the second fingerprint information storage unit, using a geometric hashing technique.

To achieve the above objects, according to still another aspect of the present invention, there is provided a fingerprint authentication method using a secret distribution technique, comprising the steps of: concealing fingerprint information by inserting chaff minutiae into a plurality of fingerprint information constituted as minutiae on an authenticated user's fingerprint image; distributively registering the authenticated user's fingerprint information that includes a portion of the concealed fingerprint information in a server and other fingerprint information of the concealed fingerprint information, not registered in the server, in the authenticated user's security token; aligning the authenticated user's fingerprint information registered in the server and input fingerprint information, generating partial alignment fingerprint information of the authenticated user's fingerprint information registered in the server and the input fingerprint information, and transmitting it to the security token; aligning the authenticated user's fingerprint information registered in the security token based the transmitted partial alignment information; and performing a user authentication by determining whether the input fingerprint information is matched with the authenticated user's fingerprint information using the fingerprint information aligned in the server and the security token.

In the distributively registering the authenticated user's fingerprint information, only the number of user's minutiae less than the number of the authenticated user's minutiae may be stored in the security token so that a polynomial cannot be restored using only the user's minutiae in the security token.

Meanwhile, it is preferable that the minutiae having a high reliability are stored in the server so that the server can select exact partial alignment information when the fingerprint information is distributively stored.

The step of partially aligning the fingerprint information of the authenticated user registered in the server and the step of aligning the fingerprint information registered in the security token based on the transmitted partial alignment information are performed by generating a hash table with the minutiae information by converting all minutiae in order to automatically align the minutiae in the server, generating partial alignment information by converting a partial reference point information of the information generated as the hash table, showing a highest matching rate with the input fingerprint, and the matched minutiae information for the user authentication, and transmitting it to the security token.

Also, the security token generates the hash table of the input fingerprint using only the transmitted partial alignment information, differently from the minutiae auto-alignment method in the server, thereby performing the auto-alignment of the input fingerprint in order to reduce the calculation of the security token and to compare the minutiae of the security token.

With the present invention, the fuzzy vault theory is used in order to protect biometric information, and the authenticated user's fingerprint information is distributively stored in each of the plurality of storage units such as the server and the security token, making it possible to securely protect personal information.

Also, the auto-alignment method is provided by extracting the fingerprint information in each of the plurality of storage units, making it possible to be used as a policy to store fingerprint information in an auxiliary storage apparatus, such as the security token, in a ubiquitous embedded environment and also to optimize availability of memory or information used in the existing fingerprint information server, etc.

The present invention, which can solve a problem of privacy that is a problem of a biometric recognition technique, provides the fingerprint authentication method characterized by the distribution technique of the fingerprint minutiae and the auto-alignment method of the multiple storage units such as the security token and the server, making it possible to obtain economic effects to increase sales in the biometric recognition industry.

### BRIEF DESCRIPTION OF THE DRAWINGS

These and other objects, features, aspects, and advantages of the present invention will be more fully described in the following detailed description of preferred embodiments and examples, taken in conjunction with the accompanying drawings. In the drawings:

FIG. 1 is a flowchart showing a fingerprint authentication method using a secret distribution technique according to one embodiment of the present invention;

FIG. 2 is a schematic view showing a fingerprint information storage apparatus using the secret distribution technique according to the embodiment of the present invention, and a storage method thereof; and

FIG. 3 is a schematic view showing a portion of an authentication process of the fingerprint authentication system using the secret distribution technique according to the embodiment of the present invention.

### DETAILED DESCRIPTION OF THE INVENTION

Hereinafter, exemplary embodiments of the present invention will be described in detail with reference to the accompanying drawings.

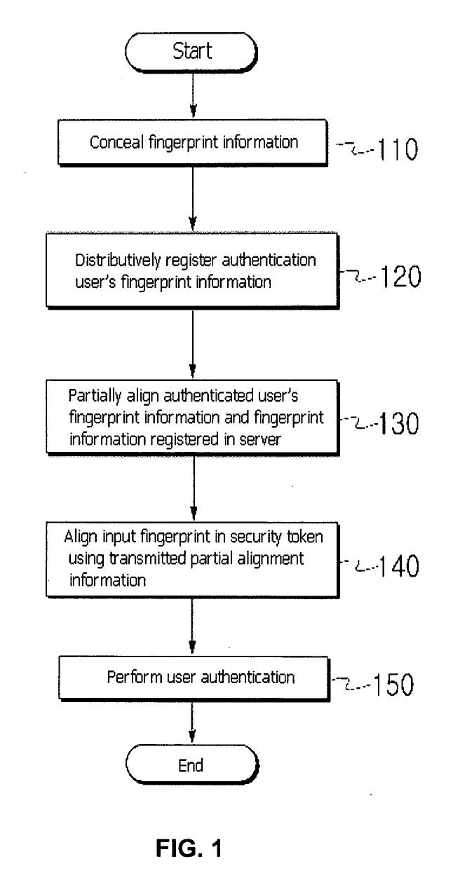

FIG. 1 is a flowchart showing a fingerprint authentication method using a secret distribution technique according to an embodiment of the present invention.

First, fingerprint information is concealed by inserting chaff minutiae into a plurality of fingerprint information that are constituted by minutiae in an authenticated user's fingerprint image (110).

Next, the authenticated user's fingerprint information is distributively registered by registering a portion of the concealed fingerprint information in a server and registering other fingerprint information of the concealed fingerprint information, which is not registered in the server, in the authenticated user's security token (120).

A partial alignment of the authenticated user's input fingerprint information and the fingerprint information stored in the server is performed (130), and the input fingerprint information in the security token is aligned using the transmitted partial alignment information (140).

Finally, a user authentication is performed (150).

Each step will be described in more detail below.

Generally, in the security token-based authentication system, an authentication method to use a user's fingerprint information is used, instead of a password, where the fingerprint information may be leaked or misused due to the loss or forgery of the security token. Therefore, there is a need for a method to protect the fingerprint information that prevents the fingerprint information of the security token from being leaked and to allow the user authentication not to be performed only with the fingerprint information of the security token. In other words, there is a need for a method to prevent the entirety of the fingerprint information from being leaked by dividing and storing the authenticated user's fingerprint information into the security token and the server, likewise the process of protecting the security token-based fingerprint information (120), and to perform the authentication using all of the fingerprint information in the security token, the user's input fingerprint information, and the fingerprint information in the server in the user authentication step.

In the embodiment of the present invention, the fingerprint information in the security token is protected by broadly applying the secret distribution concept that becomes the basis of the fuzzy vault theory. In other words, when the fingerprint information that is secret information is distributively between the security token and the server, an attacker should know all of the fingerprint information stored in the respective security token and server in order to know the user's fingerprint information.

When the fingerprint template to which the fuzzy vault is applied is divided and stored in order to protect the fingerprint information, the fingerprint recognition rate and the security vary depending on the number of fingerprint minutiae to be divided. Therefore, there is a need for a method to divide and store the fingerprint template in consideration of both the fingerprint recognition rate and the security.

First, the number of minutiae to be stored in the security token is determined in order to distributively store the fingerprint template. The authenticated user's minutiae are used in order to restore a polynomial used in the fuzzy vault theory. At this time, if the order of the polynomial is d, d+1 user's minutiae are required in order to restore the polynomial.

Therefore, in the case of the security token, the user minutiae having the number less than d+1 are stored in the security token so that the polynomial cannot be restored using only the user minutiae.

Also, the position of the minutiae to be stored in the security token affects the recognition rate. If the reliability of information in the minutiae that determines the partial alignment information in the server is low, the alignment of the minutiae in the security token cannot be performed properly.

Therefore, it is required to consider the position of the minutiae in the method to distributively store the minutiae.

Most of the minutiae are concentrated on the center of the fingerprint and extraction frequency thereof is high so that if the minutiae located near a central point are selected as reference points, the minutiae are highly likely to be aligned properly. In other words, the minutiae positioned near the central point of the fingerprint may have reliability higher than minutiae positioned in other locations, where minutiae positioned near the edges of the fingerprint have low reliability. Therefore, when the fingerprint template is distributively stored, the minutiae having high reliability are stored in the server so that the server can select the exact partial alignment information.

Next, as the step of the fingerprint auto-alignment method in the security token and the server, the steps 130 to 150 are performed.

The minutiae auto-alignment in the server is performed in the user authentication step. In the embodiment of the present invention, the problem of auto-alignment is solved by applying the geometric hashing technique to the server and the security token, respectively. However, the geometric hashing technique generates the minutiae information converted based on all of the minutiae into hashing tables, requiring a great memory capacity. Furthermore, the security token usually has only limited resources so that it is often required to efficiently apply the geometric hashing method.

Therefore, when the auto-alignment is performed in the security token, information is aligned using the partial alignment information that is a portion of the auto-alignment information performed in the server. Also, since the partial alignment information includes fingerprint information, the leakage of the fingerprint information should be prevented in the transmitting step.

As the user authentication step, first, the minutiae in the server are compared with the input fingerprint (130). In other words, in this step, a hash table is generated from the minutiae in the server using the geometric hashing technique and is compared with the input fingerprint.

Next, the partial alignment information is selected in the server and is transmitted to the security token. The partial alignment information, which is alignment information necessary for automatically aligning the minutiae in the security token, includes information of minutiae that are highly likely to be selected as reference when automatically aligning the whole fingerprint minutiae. However, since the partial alignment information includes a portion of the fingerprint information, a problem arises in that the information of minutiae may be leaked in the transmitting step.

Therefore, the partial alignment information is generated by using the information of the matched minutiae (a registered fingerprint of which an alignment step is performed and an input fingerprint) and the distance of the minutiae, before the input fingerprint is converted, without transmitting the information of minutiae that is the reference point of the server. Also, the server restores the d′ order polynomial lower than d order polynomial using the matched minutiae and generates the partial alignment information using the restored polynomial coefficient.

The last process of the user authentication comparing the security token with the input fingerprint. The security token usually has a limited computational resource, so that it applies a geometric hashing technique that uses only the partial alignment information transmitted from the server, unlike the geometric hashing technique that is used as the auto-alignment method of the minutiae in the server. The security token generates the hash table of the input fingerprint using only the transmitted partial alignment information and compares it with the minutiae stored in the security token (140). Also, the user authentication is confirmed by performing the restoration of the d order polynomial using the matching results and the d′ order polynomial coefficient of the partial alignment information (150).

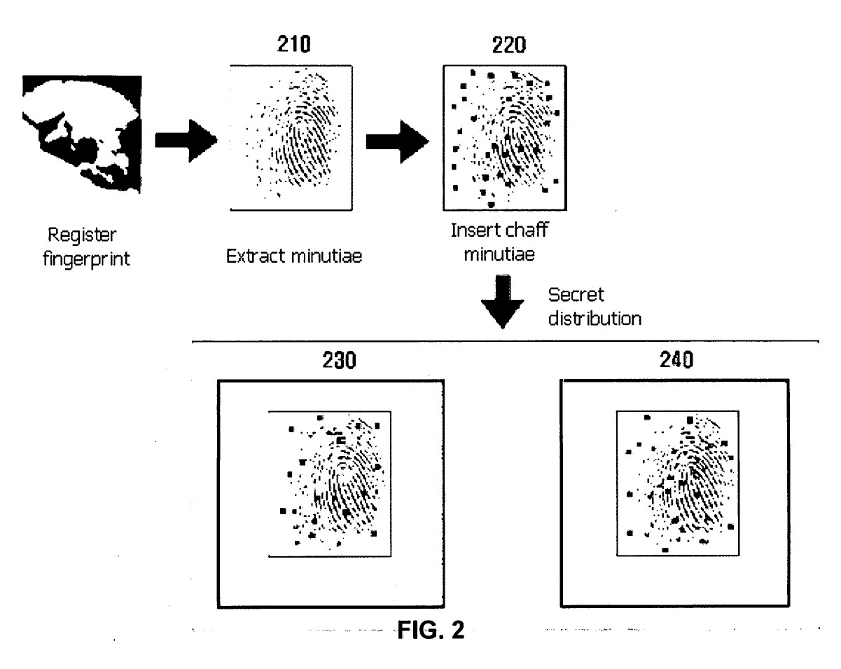

FIG. 2 is a schematic view showing a fingerprint information storage apparatus using the secret distribution technique according to the embodiment of the present invention, and a storage method thereof.

In other words, referring to FIG. 2, it shows a process where the authenticated user stores and registers his or her fingerprint information in a plurality of storage units.

First, if a fingerprint image of the authenticated user is captured, a real fingerprint information generating unit 210 extracts the authenticated user's real minutiae by receiving the fingerprint image information, and generates the minutiae information such as position, angle, shape, and distribution based on the central point of the fingerprint, etc. thereof.

Next, a negative real fingerprint information generating unit 220 generates chaff fingerprint information including a position, an angle, a shape, and a distribution based on the central point of the fingerprint, etc., of the minutiae, and inserts the generated chaff fingerprint information into the registered real minutiae.

The real fingerprint information generating unit 210 and the negative real fingerprint information generating unit 220 together form a fingerprint information generating unit.

The fingerprint information generating unit generates a fingerprint template through the processes of extracting the minutiae of the authenticated user's registered fingerprint input through a sensor and inserting the chaff minutiae.

Although not shown in FIG. 2, the fingerprint storage apparatus and the fingerprint authentication system according to the embodiment of the present invention may include a fingerprint information distributing unit that classifies the fingerprint template based on the reliability of the minutiae, and distributes and outputs the fingerprint information according to the reliability of the minutiae. The generated fingerprint template is distributively stored in the plurality of storage units based on the reliability and security of the minutiae.

In the embodiment of the present invention, among the storage units, fingerprint information in which fingerprint minutiae have high reliability is stored in a first fingerprint information storage unit 230 and fingerprint information on fingerprint minutiae not stored therein is stored in a second fingerprint information storage unit 240.

The first fingerprint information storage unit may be included in the server, and the second fingerprint information storage unit may be included in the security token.

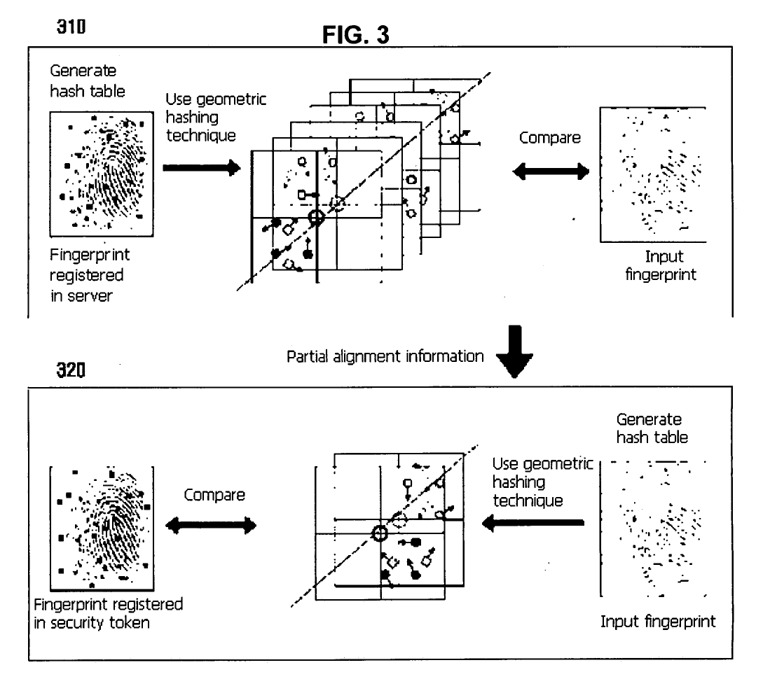

FIG. 3 is a schematic view showing a portion of an authentication process of the fingerprint authentication system using the secret distribution technique according to the embodiment of the present invention.

Referring to FIG. 3, in the server 310 that includes the first fingerprint information storage unit and the security token 320 that includes the second fingerprint information storage unit, methods to automatically align the fingerprint information are described.

In order to automatically align the minutiae of the fingerprint information stored in the server 310, the server 310 generates the minutiae information in the form of a hash table by converting all of the minutiae.

Among the information generated as the hash table, the information that partial reference point information showing a highest matching rate with the input fingerprint is converted and the polynomial coefficient necessary in the user authentication are generated and transmitted to the security token 320. The security token 320 generates the partial hash table of the input fingerprint using only the transmitted partial alignment information, unlike the minutiae fingerprint information auto-alignment method in the server, thereby reducing the calculation of the security token and performing the auto-alignment of the fingerprint information of the minutiae stored in the security token.

Although the present invention has been described in detail with reference to its presently preferred embodiment, it will be understood by those skilled in the art that various modifications and equivalents can be made without departing from the spirit and scope of the present invention, as set forth in the appended claims. Also, the substances of each constituent explained in the specification can be easily selected and processed by those skilled in the art from the well-known various substances. Also, those skilled in the art can remove a part of the constituents as described in the specification without deterioration of performance or can add constituents for improving the performance. Furthermore, those skilled in the art can change the order to methodic steps explained in the specification according to environments of processes or equipments. Thus, it is intended that the present invention covers the modifications and variations of this invention provided they come within the scope of the appended claims and their equivalents.

What is claimed is:

1. A fingerprint information storage apparatus comprising:
a fingerprint information distributing unit that classifies an authenticated user's fingerprint information based on how minutiae are distributed relative to a center of the fingerprint and distributively outputs the fingerprint information according to the distribution of the minutiae; and
a first fingerprint information storage unit and a second fingerprint information storage unit that store the fingerprint information distributively outputted by the fingerprint information distributing unit.

2. The fingerprint information storage apparatus according to claim 1, wherein the first fingerprint information storage unit stores fingerprint information in which the minutiae have a low distribution relative to the center of the fingerprint, and the second fingerprint information storage unit stores fingerprint information in which the minutiae have a high distribution relative to the center of the fingerprint.

3. The fingerprint information storage apparatus according to claim 2, wherein the first fingerprint information storage unit is a server and the second fingerprint information storage unit is a security token.

4. The fingerprint information storage apparatus according to claim 3, wherein the number of minutiae stored in the security token is less than the number of minutiae of the authenticated user.

5. The fingerprint information storage apparatus according to claim 1, further comprising:
a fingerprint information generating unit that extracts minutiae information from the authenticated user's fingerprint image and generates fingerprint information by inserting chaff minutiae information into the extracted minutiae information,
wherein the fingerprint information generating unit further includes:
a real fingerprint information generating unit that extracts minutiae from the authenticated user's fingerprint image input by a sensor and registers fingerprint information, including a position of the minutiae, an angle of the minutiae, a shape of the minutiae, and a distribution of the minutiae relative to the center of the fingerprint; and
a negative real fingerprint information generating unit that generates chaff fingerprint information including a position, an angle, a shape, and a distribution relative to the center of the fingerprint, of the minutiae, and inserts the generated chaff fingerprint information into the registered real fingerprint information.

6. A fingerprint authentication system using a secret distribution technique, comprising:
a input fingerprint information generating unit that extracts minutiae from an authenticated user's input fingerprint image and generates fingerprint information including a position of the minutiae, an angle of the minutiae, a shape of the minutiae, and a distribution of the minutiae relative to the center of the fingerprint;
a primary registration hash table generating unit that extracts pre-registered fingerprint information from a first fingerprint information storage unit that extracts minutiae information from an authenticated user's fingerprint image, generates fingerprint information by inserting chaff minutiae information into the extracted minutiae information and is stored with fingerprint information of the fingerprint information, having a low distribution relative to the center of the fingerprint, and generates a primary registration hash table using a geometric hashing technique;
a primary fingerprint information aligning and matching unit that matches fingerprint information by aligning the primary registration hash table and then deletes chaff fingerprint information;
a partial alignment fingerprint information generating and transmitting unit that generates partial alignment information using the aligned and matched fingerprint information and the input fingerprint information and transmits the partial alignment information;
a secondary registration hash table generating unit that extracts pre-registered fingerprint information from the second fingerprint information storage unit stored with fingerprint information of the authenticated user's fingerprint information, having a high distribution relative to the center of the fingerprint, and generates a secondary registration hash table using a geometric hashing technique;
a secondary fingerprint information aligning and matching unit that matches fingerprint information by aligning the secondary registration hash table and then deletes chaff fingerprint information; and
a user authenticating unit that detects authentication results of the input fingerprint information from the primary fingerprint information aligning and matching unit and the secondary fingerprint information aligning and matching unit.

7. A fingerprint authentication method using a secret distribution technique, comprising the steps of:
distributively registering fingerprint information that extracts minutiae information from an authenticated user's fingerprint image, generates fingerprint information by inserting chaff minutiae information into the extracted minutiae information, registers a portion of the generated fingerprint information in a first fingerprint information storage unit, and registers other fingerprint information, which is not registered in the first fingerprint information storage unit, in a second fingerprint information storage unit;
aligning primary fingerprint information that aligns the fingerprint information registered in the first fingerprint information storage unit and input fingerprint information;
generating partial alignment fingerprint information of the fingerprint information registered in the first fingerprint information storage unit and the input fingerprint information and transmitting it to a second fingerprint information storage unit;
aligning secondary fingerprint information that aligns the input fingerprint information using the transmitted partial alignment fingerprint information and the fingerprint information registered in the second fingerprint information storage unit; and
detecting authentication results to determine whether the input fingerprint information matches the authenticated user's fingerprint information using the results from the aligning steps.

8. The fingerprint authentication method according to claim 7, wherein the fingerprint information stored in the first fingerprint storage unit includes minutiae information from the authenticated user's fingerprint image and has a low distribution of the minutiae when the minutiae are classified according to how the minutiae are distributed relative to the center of the fingerprint.

9. The fingerprint authentication method according to claim 8, wherein the fingerprint information having the low distribution of the minutiae has the distribution ranked lower than 50%, in the distribution of all the minutiae of the authenticated user.

10. The fingerprint authentication method according to claim 7, wherein the first fingerprint information storage unit is a server and the second fingerprint information storage unit is a security token.

11. The fingerprint authentication method according to claim 10, wherein the number of minutiae stored in the security token is less than a total number of minutiae of the authenticated user.

12. The fingerprint authentication method according to claim 7, wherein the minutiae information is at least one information selected from a position of the minutiae, an angle of the minutiae, a shape of the minutiae, and a distribution of the minutiae relative to the center of the fingerprint.

13. The fingerprint authentication method according to claim 7, wherein the step of aligning the primary fingerprint information and the step of aligning the secondary fingerprint information comprise generating and aligning respective hash tables with the fingerprint information registered in the first fingerprint information storage unit, the input fingerprint information, the input fingerprint information using the transmitted partial alignment fingerprint information and the fingerprint information registered in the second fingerprint information storage unit, using a geometric hashing technique.
